(19) United States
(12) Patent Application Publication
(10) Pub. No.: US 2014/0051032 A1
(43) Pub. Date: Feb. 20, 2014

(54) COATING FOR A DENTAL MATRIX BAND

(71) Applicant: Fly Cast Technologies, Inc., Libertyville, IL (US)

(72) Inventor: Robert E. Haraden, Libertyville, IL (US)

(73) Assignee: Fly Cast Technologies, Inc., Libertyville, IL (US)

(21) Appl. No.: 14/067,160

(22) Filed: Oct. 30, 2013

Related U.S. Application Data
(63) Continuation-in-part of application No. 13/317,429, filed on Oct. 18, 2011.

(51) Int. Cl. A61C 5/12

(52) U.S. Cl. CPC A61C 5/125
USPC 433/39; 427/2.29

(57) ABSTRACT

A matrix band for use in dentistry has a silicone-based, polymer coating applied to a stainless steel or a polyester surface, which reduces or eliminates capillary action between a tooth and the matrix band. The matrix band may include at least one aperture to assist with removal of the matrix band from the tooth.

### CROSS-REFERENCE TO RELATED APPLICATIONS

This application is a continuation-in-part of U.S. patent application Ser. No. 13/317,429 filed on Oct. 18, 2011.

### TECHNICAL FIELD OF THE INVENTION

This invention relates to a coating for a dental matrix band and more particularly to a coating for a dental matrix band based on silicone applied to an etched metal dental matrix band. The invention also relates to a silicone coating on a polyester dental matrix band.

### BACKGROUND OF THE INVENTION

A matrix band is a common tool used in dentistry. Typically, the matrix band is a thin, flexible piece of material. Generally speaking, the matrix band is metallic in nature, or a plastic, such as polyester. After the dentist prepares the tooth and removes decay, the dentist will position the band around a tooth to be filled. The band is then tightened around the tooth, with a clamping device called a dental matrix band retainer, in order to form a mold or an appropriate support for applying a filling material to the tooth.

The matrix band of the prior art is metallic, usually comprising stainless steel. The matrix band must be substantially impervious to, or not reactive with, fluids in a person's mouth. The matrix band must also be made of a material that is nontoxic. Because the use of a dental matrix band is well defined in U.S. Pat. No. 5,586,883 to Nakisher and Uditsky, incorporated herein by reference, the use thereof need not be further defined.

There are a number of different dental matrix bands or devices currently on the market: Universal Adult Matrix Band (available in sizes of 0.001 inch to 0.002 inch); Adult Molar Matrix Band; Child Matrix Band; Auto Matrix System, and Sectional Matrix Band Systems.

Although the matrix band is a common and long-used dental implement, problems do exist with the currently used technology. Firstly, capillary action between the matrix band and the tooth causes at least one body fluid, to dampen or contaminate the surface of the tooth being filled. This is extremely undesirable since the presence of an undesirable fluid in the area interferes with the adhesion property and reduces the bond strength of the cavity filling material to the tooth, and causes deterioration of the cavity filling material.

Typically, body fluids interfere with this dental restorative procedure include, but are not limited to, blood and saliva. Interference is caused between the tooth and the filling material, because the optimum bond strength of a filling to a tooth occurs when the tooth remains dry during the entire procedure, and the mechanical strength of the filling material to be maximized.

Another difficulty with a matrix band of the prior art is the tendency of the bands to adhere to the cavity filling material. This adherence may make the matrix band difficult to remove from the tooth, when the filling process is complete, and may require the dentist to exert extra force on the new composite filling used on the patient in order to remove that matrix band. A difficult removal of the sticking matrix band is uncomfortable for the patient, and causes both weakness of the bond between the cavity filling material and the filling material to leak overtime, thereby reducing the longevity of the dental filling. Without a good bond between filling material and the tooth, the dental procedure significantly increases the probability of recurrent decay.

Still another difficulty of currently utilized matrix bands is the flat surface of the bands, which contain no indentations where a dental instrument can be used to grasp the band to assist in removing the band after the cavity has been filled. This makes the removal of the band more difficult.

Many devices are known in the prior art, which allegedly permit easy removal of a matrix band from a tooth. One attempt to solve the problem included making the matrix band with gold plating. However, this ultra-thin layer of gold-plated matrix band does not completely solve or eliminate the ingress of fluid, which causes contamination and undesired body fluid flow into the desired work area.

While it is not desired to be bound by any particular theory, the capillary action is believed to occur because the solid gold or gold alloy matrix band, as well as the gold-plated matrix band is not soft enough or thick enough to form a seal with the tooth, thereby failing to eliminate the ingress of fluid due to capillary action.

While polymer coatings can successfully form a seal with the tooth, the adherence of the polymer to the matrix band or the separating strip for dental purposes is often defective. If the coating does not properly adhere to the matrix band, the coating shears off the stainless steel and remains stuck between the teeth or may remain in the composite dental filling material.

### SUMMARY OF THE INVENTION

The present disclosure relates to a dental matrix band seal in combination with a matrix band. The matrix band is coated with a silicone-based polymer, which at least minimizes the ingress of fluid between the matrix band and the tooth, by creating a seal which keeps the surface of the tooth dry during the filling process.

In an embodiment, a dental matrix band or sectional matrix band for use in dentistry is described. The matrix band comprises a thin, flexible strip of pharmaceutically acceptable material, the strip being configured for positioned around a tooth, a polymer barrier layer applied to a surface of the flexible strip, wherein the polymer barrier layer minimizes ingress of fluid to an area between the flexible strip and the tooth to which it is positioned around.

In another embodiment, a dental matrix band seal is described. The matrix band seal comprises a flexible plastic material having a surface, the strip being configured for positioning around a tooth, a polymer coating applied to the surface of the strip, wherein when the flexible plastic material is positioned around a tooth, the polymer coating is in direct contact with an outer surface of the tooth.

In yet another embodiment, a matrix band or sectional matrix band for use in dentistry is described. The matrix band comprises a thin, flexible strip of pharmaceutically acceptable material, the strip being configured for positioned around a tooth, a barrier layer applied to a surface of the flexible strip, wherein the barrier layer minimizes ingress of fluid to an area between the flexible strip and the tooth to which it is positioned around.

A method for making a coated matrix band or section matrix band for use in dentistry is described. The method comprises the steps of priming a surface of a thin, flexible strip of material, applying a capillary-reducing polymer coating to the primed surface of the flexible strip, and adhering the coating to the flexible strip.

These and other aspects of the dental matrix band may be understood more readily from the following description and the appended drawings.

### BRIEF DESCRIPTION OF THE DRAWINGS

FIG. 1 depicts a perspective view of a straight coated matrix band 100 with a silicone polymer 120 of this invention;

FIG. 2 depicts a perspective view of a contoured matrix band 101 of this invention;

FIG. 2A depicts a perspective view of a cross-section of the contoured matrix band 101 of FIG. 2;

FIG. 3 depicts a sectional matrix band 102 of this invention;

FIG. 4 depicts a perspective view of a straight coated matrix band 100 with a silicone polymer 120 of this invention, with a partial cross-section and a metal or plastic base 114;

FIG. 5 depicts a side view of the straight 100 or contoured 101 coated matrix band around a tooth 110;

FIG. 6 depicts a side view of the sectional matrix band 102 around a tooth; and,

FIG. 7 depicts a cross-sectional view of the dental matrix band.

Throughout the figures of the drawings, where the same part appears in more than one figure of the drawings, the same number is applied thereto.

### DETAILED DESCRIPTION OF THE INVENTION

With the matrix band of this invention being suitable for use in dental procedures and having a coated surface thereon, capillary action between the tooth and the band is at least substantially reduced, if not eliminated.

The concept disclosed and claimed herein may be described as a dental matrix seal and is applicable to any dental matrix device, regardless of the geometric shape of the dental matrix device. Shapes of the dental matrix band useful in the present disclosure include straight, simple contoured and fully contoured and sectional. The geometric shape of the seal may be useful for different procedures and tooth types, but is irrelevant to the function of the seal. The advantages of using a Silicone coated dental matrix band are as follows:

1) The Silicone coating eliminates the capillary action, wicking or osmotic migration from the body fluids from the dental sulcus contaminating the dental filling material during the filling process. This contamination reduces the bond strength of the composite dental filling material from bonding to the tooth. More specifically the bonding of the composite to the dentinal tubules is prevented.

2) The Silicone coating requires less tightening torque and less pressure on the matrix band retainer to achieve a seal of the tooth dental preparation area from body fluids (saliva and blood). The reduction in torque on the dental matrix band eliminates the potential of the dental matrix band from fracturing and breaking during the application procedure. Sectional matrix band systems benefit from less ring pressure and less wedging force.

3) Using Silicone coating on the metal, such as stainless steel, plastic or polyester matrix band, i.e., Mylar, eliminates or reduces the roughness of the surface of the dental matrix band both the plain stainless steel, the tin coated stainless steel and polyester. The rough surface causes the composite dental filling material to stick to the dental band and cause the filling material to be rough inter-proximally (between the two adjacent teeth). This inter-proximal surface cannot be smoothed after the dental filling has been placed. When the dental matrix band sticks to the filling material the band fractures and breaks upon removal causing the band to be dangerous to the operator (dentist or assistant).

Polydimethylsiloxane is the active coating material.

The dental matrix bands are preferably coated with NuSil product Med10-6640 two part Platinum catalyzed polydimethyl siloxane. Primer use before coating is Med 1-161 silicone primer. These NuSil products are available from, NuSil Technology LLC, 1050 Cindy Lane, Carpinteria, Calif. 93013.

Adhesion of the coating as dental matrix seal to a metal dental matrix device is assured by the rough tin plating or etching the surface of the dental matrix device. Etching of the matrix band may be accomplished in any suitable fashion. Mechanical abrasion, acid etching and photochemical etching are especially suitable processes for etching the matrix band, as long as the procedures are pharmaceutically acceptable. Pharmaceutically acceptable includes those materials suitable for use in a person's mouth.

Additionally, the metal matrix band may be etched by using mechanical abrasion. Mechanical abrasion may be obtained by subjecting the metal surface to a high velocity stream of silica particles or soft metal particles, or by rubbing the surface with a silica or diamond encrusted paper or metal sheet. Clearly, any abrasive system may be used. However, the chemical treatment is preferred.

The preferred method of applying coating, laminate or tapes to the separating strip is by using a pharmaceutically acceptable adhesive, but any other suitable method may be used.

Coatings with a thickness of about 0.0001″ to about 0.0005″ are adequate to reduce the capillary action. Coatings with a thickness of about 0.0001″ to about 0.0003″ reduce the capillary action more effectively.

Referring now to the drawings, the following references to specific drawing figures are intended to illustrate without unduly limiting the invention disclosed herein. The polyester matrix band of the present disclosure is coated with silicone barrier layer using know methods for coating with silicone.

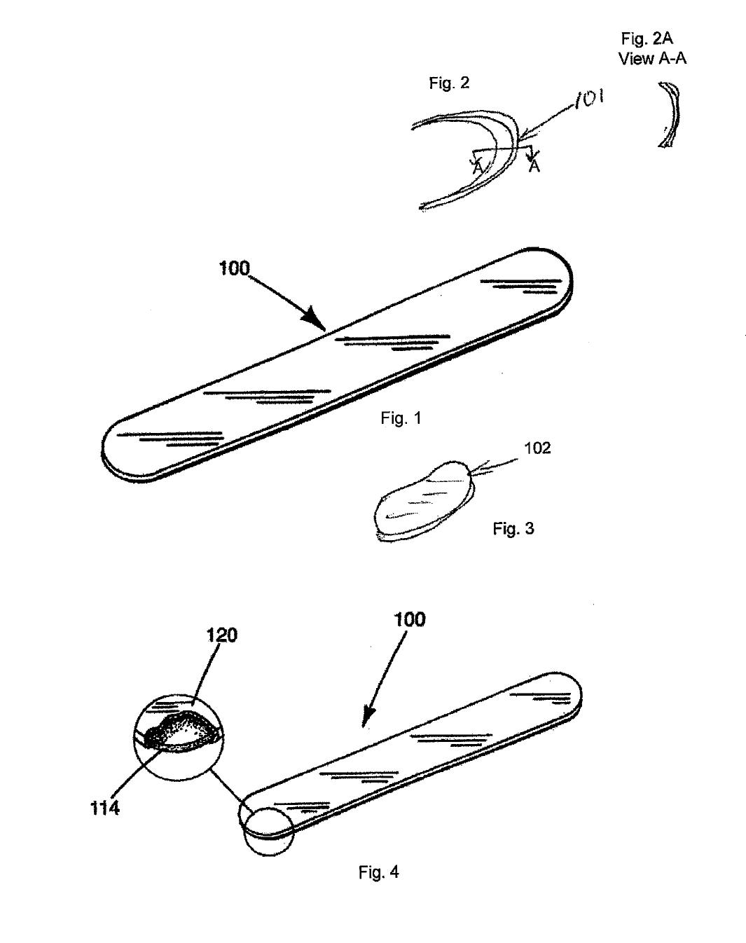

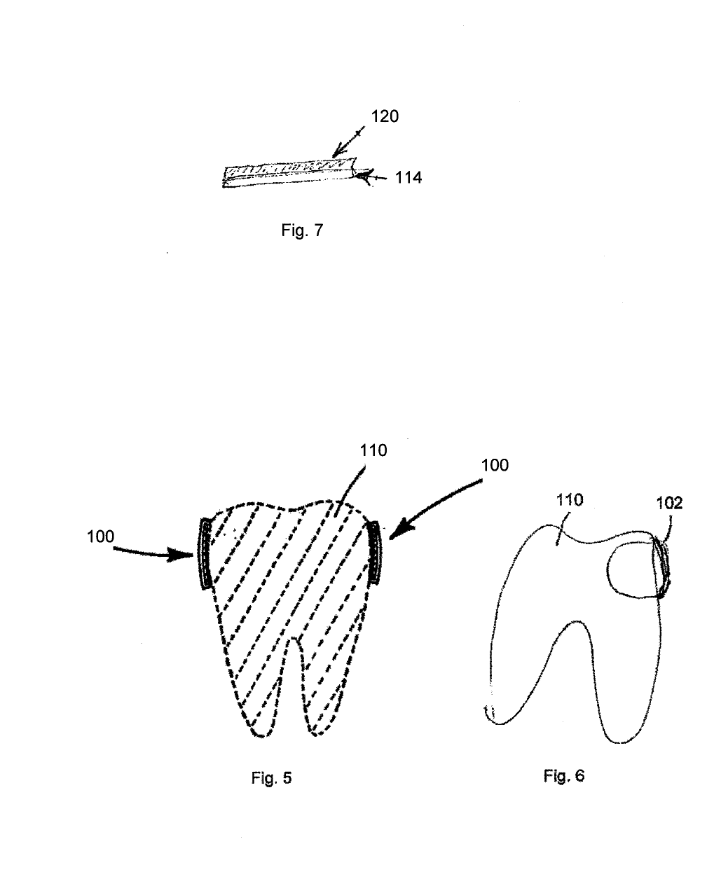

Considering now FIG. 1, FIGS. 2 and 2A, FIG. 3, FIG. 4, FIG. 5 and FIG. 6, the straight 100, contoured 101 or sectional 102 coated matrix band has a support base 114 with a polymer coating 120 applied thereto. For convenience, the straight matrix band 100 will be referenced; however, it should be understood the present disclosure is not limited to any particular shape. The support base 114 may be a stainless steel, plastic or polyester material. The polymer coating 120 is applied after the support base 114 is etched or plated with tin, if the support base is stainless steel. If the support base 114 is polyester, the polymer coating 120, such as silicone, is coated onto the polyester strip by known methods. The support base 114 may have a rectangular cross section (FIG. 7) although other suitable geometric shapes may be used, including contoured matrix bands. As shown in FIG. 5, the straight coated matrix band 100 is applied to a tooth 110, while FIG. 6 illustrates a sectional matrix band applied to a tooth 110. Matrix band 100 may also have removal apertures as shown in U.S. Pat. No. 6,749,429, to Haraden et al., incorporated herein by reference.

In the following examples, which are intended to illustrate without unduly limiting the invention disclosed herein, all parts and percentages are by weight, unless otherwise specified.

### EXAMPLE ONE

With the straight coated matrix band 100, a silicone polymer coating 120 is applied onto a stainless steel support base 114 etched in an acidic solution having a pH of 5.5, the polymer coating 120 being based on a pharmaceutically acceptable siloxane polymer. That straight coated matrix band 100 is applied to a tooth 110 under repair, where the coating provided a seal that prevented the ingress of fluid into the area of the tooth being repaired.

### EXAMPLE TWO

The procedure of Example One is repeated except that the etching solution is phosphoric acid and has a pH of 5.0. The coating adheres as well as in Example One.

### EXAMPLE THREE

The procedure of Example One is repeated except that the etching solution has a pH of 4.7. The coating adheres adequately but is not as durable as the coating set forth in Example Two.

### EXAMPLE FOUR

The procedure of Example One is repeated except that the etching solution has a pH of 6.2. The coating fails to adhere as in Example One.

### EXAMPLE FIVE

The procedure of Example One is repeated except that the etching solution has a pH of 4.0. The integrity of the support base 114 is compromised in that matrix is of insufficient strength to fit around tooth 110.

### EXAMPLE SIX

The procedure of Example One is repeated except that the acid etching process is replaced with the photo etching process. The coating adheres and provides an effective dental straight coated matrix band 100.

### EXAMPLE SEVEN

The procedure of Example One is repeated except that the acid etching process is replaced with the mechanical abrasion process utilizing a high velocity stream of silica aimed at the surface of the band to etch the surface. The coating adheres and provides an effective dental straight coated matrix band 100.

### EXAMPLE EIGHT

The procedure of Example Seven is repeated except that the acid etching process is replaced with the mechanical abrasion process utilizing a high velocity stream of soft metal particles aimed at the surface of the band. Such action forms a micro alloy on the surface. The coating forms and provides an effective seal that prevented the ingress of fluid into the area of the tooth being repaired.

### EXAMPLE NINE

The procedure of Example One is repeated except that the acid etching process is replaced with the mechanical abrasion process involving the buffing of the matrix band's surface with a silica or diamond encrusted sheet to etch the surface of the matrix band. The coating adheres and provides an effective seal that prevented the ingress of fluid into the area of the tooth being repaired.

This application taken as a whole with the abstract, specification, claims, and drawings being combined, provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and device can become clear to a person having ordinary skill in this particular art. Such modifications are clearly covered by this disclosure.

What is claimed is:

1. A matrix band or sectional matrix band for use in dentistry comprising:
a thin, flexible strip of pharmaceutically acceptable material, the strip being configured for positioning around a tooth;
a polymer barrier layer applied to a surface of the flexible strip;
wherein when the strip is positioned around the tooth, the polymer barrier coating minimizes ingress of fluid to an area between the flexible strip and the tooth to which the strip is positioned around.

2. The matrix band or sectional matrix band of claim 1, wherein the material is polyester.

3. The matrix band or sectional matrix band of claim 1, wherein the polymer barrier layer includes a pharmaceutically acceptable material.

4. The matrix band or sectional matrix band of claim 3, wherein the barrier layer further comprises a pharmaceutically acceptable polymer including one of either silicone and polysiloxane.

5. The matrix band or sectional matrix band of claim 1, wherein the polymer barrier layer is coated on a surface of the flexible strip which contacts a tooth during use.

6. The matrix band or sectional matrix band of claim 1, wherein the polymer barrier layer provides a seal between the flexible metal strip and the tooth to which it is positioned around.

7. The matrix band or sectional matrix band of claim 1, wherein the flexible strip material has a thickness in the range of from 0.001″ to about 0.0015″.

8. The matrix band or sectional matrix band of claim 1, wherein the polymer barrier layer has a thickness in the range of from about 0.0001″ to about 0.0003″.

9. A dental matrix band seal comprising:
a flexible polyester strip having a surface, the strip being configured for positioning around a tooth; and
a polymer coating applied to the surface of the strip;
wherein when the flexible polyester strip is positioned around the tooth, the polymer coating is in direct contact with an outer surface of the tooth.

10. The dental matrix band seal of claim 9, wherein the polymer coating is a barrier coating that minimizes ingress of fluid to an area between the strip and the tooth to which it is positioned around.

11. A matrix band or sectional matrix band for use in dentistry comprising:
a thin, flexible strip of pharmaceutically acceptable material, the strip being configured for positioning around a tooth; and
a barrier layer applied to a surface of the thin, flexible strip;
wherein the barrier layer minimizes ingress of fluid to an area between the thin, flexible strip and the tooth to which it is positioned around.

12. The matrix band or sectional matrix band of claim 11, wherein the barrier layer is a polymer.

13. The matrix band or sectional matrix band of claim 11, wherein the material is polyester.

14. A method for making a coated matrix band or sectional matrix band for use in dentistry, the method comprising the steps of:
priming a surface of a thin, flexible strip of material;
applying a capillary-action reducing polymer coating to the primed surface of the thin, flexible strip; and,
adhering the coating to the thin, flexible strip.
